(19) United States
(12) Patent Application Publication
(10) Pub. No.: US 2014/0301665 A1
(43) Pub. Date: Oct. 9, 2014

(54) IMAGE DATA GENERATING APPARATUS, IMAGE DATA DISPLAY SYSTEM, AND IMAGE DATA GENERATING METHOD

(71) Applicant: CANON KABUSHIKI KAISHA, Tokyo (JP)

(72) Inventors: Hiroshi Saito, Ayase-shi (JP); Hidetoshi Tsuzuki, Yokohama-shi (JP); Shuji Murakami, Zama-shi (JP); Kazuyuki Sato, Yokohama-shi (JP)

(21) Appl. No.: 14/356,025

(22) PCT Filed: Dec. 18, 2012
(86) PCT No.: PCT/JP2012/008070

§ 371 Date: May 2, 2014

(51) Int. Cl. G06T 3/40

(52) U.S. Cl. CPC G06T 3/40
USPC 382/299

(57) ABSTRACT

Provided is an image data generating apparatus includes a position data obtaining unit and a display data generating unit. The position data obtaining unit obtains position data of a plurality of regions of interest (ROIs). The display data generating unit generates first data for displaying the plurality of pieces of position data on a display device and second data which enables a part of the captured image to be enlarged and a plurality of such enlarged parts to be displayed on the display device. The part of the captured image includes the ROI corresponding to position data specified by the user among the plurality of pieces of position data displayed on the display device. As a result, a screening operation for specifying a plurality of regions of interest and detailed observation can be performed in association with, and independently of, each other.

### TECHNICAL FIELD

The present invention relates to an image data generating apparatus and an image data generating method and, in particular, to a technique for generating display image data for diagnostic imaging and improving work efficiency of pathological diagnosis.

### BACKGROUND ART

Virtual slide systems, which are a type of pathological diagnostic tools, recently have been widely noticed as an alternative to optical microscopes. Virtual slide systems take digital image of a test sample placed on a prepared slide and display on a display device. Virtual slide systems handle images of samples as digital data unlike conventional optical microscopic. The digitization is expected to gain many advantages such as speedier remote diagnosis, clearer briefings to patients with digital images, sharing of rare cases, and improving teaching/learning efficiency. Normally, the digitization of an entire test sample results in an extremely large amount of data in the order of several hundred million to several billion pixels. For this reason, image can be seen in various magnification ratios, from micro (an enlarged detailed image) to macro (an entire panoramic image), by scaling operation on an image viewer, which provide various advantages.

Meanwhile, not only in the field of pathology but in many fields, proposed are various viewers which enable immediate display of images demanded by users from low magnification images to high magnification images. For example, PTL1 discloses a technique which specifies a correspondence relationship between the cross-sectional image and an enlarged image of a partial region and thus provide a clear understanding as to which region of a cross-sectional image has been displayed in enlargement in an ultrasonic diagnostic device. In addition, PTL2 discloses a technique in which, when displaying an ultrasonic image by staged enlargement with an ultrasonic diagnostic device, a reference image generated by reducing an original image is prepared in order to facilitate understanding of a relationship among the respective images and, at the same time, enable the original image to be readily displayed.

### CITATION LIST

### Patent Literature

[PTL1]
Japanese Patent Application Laid-open No. H6-78927

[PTL2]
Japanese Patent Application Laid-open No. 2004-121652

### SUMMARY OF INVENTION

Generally, in screening for pathological diagnosis, an image is first observed in a low magnification, and regions for detailed inspection later in a high magnification are selected and marked. Although PTL1 and PTL2 both clearly specify a correspondence relationship between a low magnification image and a high magnification observation image of a region of interest (ROI), the correspondence relationship is not clearly specified if a plurality of regions of interest is selected. Therefore, it is difficult to perform screening and detailed observation as independent operations and, as a result, work efficiency declines.

In addition, observation magnification factors (display magnification factors) during observation differ between screening and detailed observation and, further, observation magnification factors during detailed observation differ among subjects or parts that are observed. Therefore, if the magnification factor for detailed observation cannot be set when specifying and marking a region of interest, the system cannot present the diagnostic image at the desired observation magnification factor during detailed observation of the region of interest. As a result, screen operations become complicated and cause a decline in work efficiency.

The present invention has been made in consideration of the problem described above and an object thereof is to provide an image data generating apparatus and an image data generating method for generating display image data for diagnostic imaging which improves work efficiency of pathological diagnosis by enabling a screening operation for specifying a plurality of regions of interest and detailed observation to be performed in association with, and independently of, each other.

The present invention in its first aspect provides an image data generating apparatus which uses data of a captured image to generate data of a display image to be displayed on a display device, the image data generating apparatus comprising: a captured image data obtaining unit configured to obtain data of captured image; a position data obtaining unit configured to obtain position data of a region of interest on the captured image instructed by a user; and a display data generating unit configured to generate data of the display image based on the data of the captured image and the position data, wherein the position data obtaining unit is capable of obtaining the position data of a plurality of the regions of interest, the display data generating unit generates first data for displaying the plurality of pieces of position data on the display device and second data which enables a plurality of enlarged images to be displayed on the display device, each enlarged image being an enlargement of a part of the captured image, and the part of the captured image includes the region of interest corresponding to position data specified by the user among the plurality of pieces of position data displayed on the display device.

Storing and retaining a plurality of pieces of position information regarding regions of interest to be enlarged for detailed observation and presenting the position information as a list enables a screening operation for specifying a plurality of regions of interest and detailed observation to be performed independently of each other and can improve work efficiency. In addition, by also storing a correspondence relationship with detailed observation magnification factors, sizes of subjects (for example, a cell nucleus and the like) can be readily compared when simultaneously displaying a plurality of detailed observation images and work efficiency can be improved.

Further features of the present invention will become apparent from the following description of exemplary embodiments with reference to the attached drawings.

### BRIEF DESCRIPTION OF DRAWINGS

FIG. 1 is a configuration diagram of an image processing system including an image data generating apparatus according to a first embodiment.

FIG. 2 is a hardware configuration diagram of an image data generating apparatus according to the first embodiment.

FIG. 3 is a functional block diagram of an image data generating apparatus according to the first embodiment.

FIG. 4A is a display screen configuration example during a screening operation according to the first embodiment.

FIG. 4B is a display screen configuration example during a screening operation according to the first embodiment.

FIG. 4C is a display screen configuration example during a screening operation according to the first embodiment.

FIG. 4D is a display screen configuration example during a screening operation according to the first embodiment.

FIG. 5 is a processing flow of display data generation during a screening operation according to the first embodiment.

FIG. 6 is a processing flow of generating or updating observation image data during a screening operation.

FIG. 7A is an example of a display screen configuration during detailed observation according to the first embodiment.

FIG. 7B is an example of a display screen configuration during detailed observation according to the first embodiment.

FIG. 7C is an example of a display screen configuration during detailed observation according to the first embodiment.

FIG. 7D is an example of a display screen configuration during detailed observation according to the first embodiment.

FIG. 8 is another example of a display screen configuration during detailed observation according to the first embodiment.

FIG. 9 is a processing flow of display image data generation during detailed observation according to the first embodiment.

FIG. 10 is a processing flow of updating an enlarged display image in a detailed observation flow.

FIG. 11 is an example of a format of a list of regions of interest that is generated during screening.

FIG. 12 is a configuration diagram of an image processing system including an image data generating apparatus according to a second embodiment.

FIG. 13 is an example of a display screen configuration during detailed observation according to the second embodiment.

FIG. 14 is a processing flow of display image data generation during detailed observation according to the second embodiment.

FIG. 15 is an example of a format of a modified region-of-interest list.

FIG. 16 is an example of a display screen configuration during detailed observation according to a third embodiment.

FIG. 17 is a processing flow of display image data generation during detailed observation according to a fourth embodiment.

### DESCRIPTION OF EMBODIMENTS

### First Embodiment

The first embodiment which realizes the present invention will now be described with reference to the drawings.

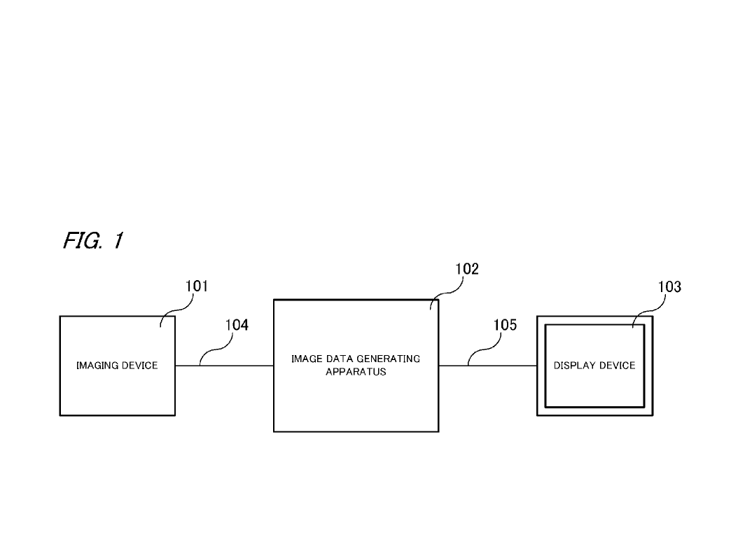

FIG. 1 is a configuration diagram which shows an image processing system (an image data display system) including an image data generating apparatus of the first embodiment of the present invention. The system shown in FIG. 1 comprises an imaging device (a microscope device or a virtual slide scanner) 101, an image data generating apparatus 102, and a display device 103. The system has a function of obtaining and displaying a two-dimensional image of a test object (a test sample). The imaging device 101 and the image data generating apparatus 102 are connected to each other by a dedicated or general-purpose I/F cable 104. The image data generating apparatus 102 and the display device 103 are connected to each other by a general-purpose I/F cable 105.

The imaging device 101 is a captured image output device which has a function of capturing a two-dimensional image and outputting the obtained two-dimensional image to an external device. The imaging device 101 may be a digital microscope device in which a digital camera is attached to an eyepiece of an ordinary optical microscope. A solid-state imaging element such as a CCD (Charge Coupled Device) or a CMOS (Complementary Metal Oxide Semiconductor) may be used for obtaining two-dimensional image data.

The image data generating apparatus 102 has a function of generating image data and display data suitable for pathological diagnosis based on two-dimensional image data obtained from the imaging device 101. The image data generating apparatus 102 may be a general-purpose computer or a work station which is capable of high-speed arithmetic processing and which comprises hardware resources such as a CPU (central processing unit), a RAM, a storage device, an operating unit, and an I/F. The storage device is a large-capacity information storage device (non-transitory computer readable medium) such as a hard disk drive and stores a program, data, an OS (operating system), and the like for realizing the various processes described later. The respective functions described above are realized as a result of the CPU loading a necessary program and data from the storage device to the RAM and executing the program. The operating unit may be constituted by a keyboard, a mouse, or the like and is used by an operator to input various instructions. A touch panel may be used as the display device 103 (described later) to enable the display device 103 to accept operation input.

The display device 103 is a monitor which has a function of obtaining image data for display generated by the image data generating apparatus 102 and displaying display data suitable for pathological diagnosis, and may be constituted by a CRT, a liquid crystal display, and the like.

While the image processing system is constituted in the example shown in FIG. 1 by three devices, namely, the imaging device 101, the image data generating apparatus 102, and the display device 103, the present invention is not limited to this configuration. For example, an image data generating apparatus integrated with a display device, or a function of an image data generating apparatus may be built into an imaging device. Alternatively, all functions of an imaging device, an image data generating apparatus, and a display device may be realized by a single device. Conversely, functions of an apparatus may be divided and realized by a plurality of devices.

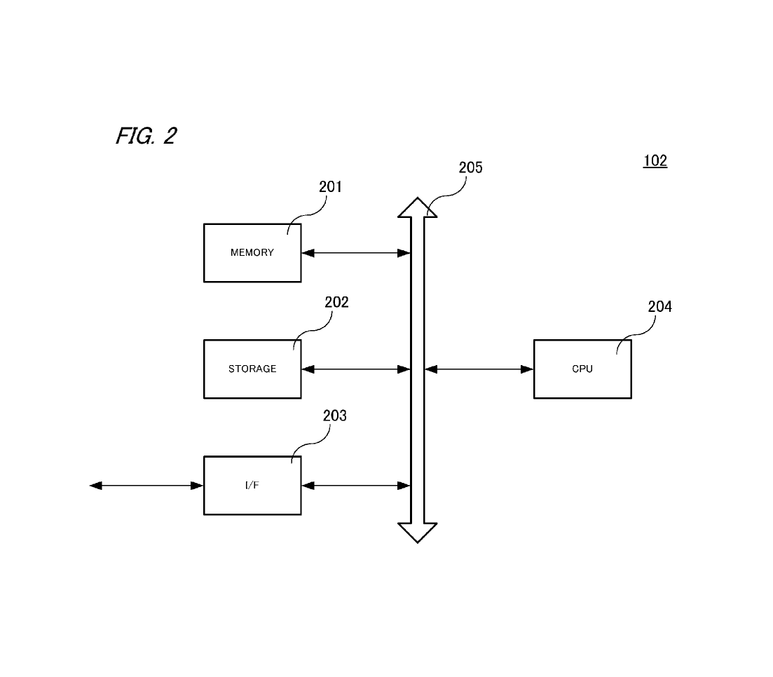

FIG. 2 is a hardware configuration diagram of the image data generating apparatus 102 of the first embodiment of the present invention. The image data generating apparatus 102 shown in FIG. 2 comprises a memory 201, a storage 202, an I/F 203, a CPU 204, and an internal bus 205.

The memory 201 is a storage device for temporal memory. The memory temporarily stores captured image data obtained by the image data generating apparatus 102 and/or internally-generated display data. The memory also is used as a work area by the CPU 204 when carrying out various processes. In this example, a DRAM device such as a DDR3 memory is used.

The storage 202 is a non-volatile storage device storing a program and data which enable the CPU 204 to execute the various processes performed by the image data generating apparatus 102. The storage 202 also stores image data, lists, and configuration data to be stored by the image data generating apparatus 102. In this example, a device such as an HDD or an SSD is used.

The I/F 203 is an interface device used by the image data generating apparatus 102 to obtain captured image data from the outside, to output display data to the outside, and/or to obtain operation information from the outside. In this example, a device supporting USB or Gigabit Ethernet (registered trademark), a DVI, or the like is used.

The CPU 204 is a processing device for executing a program that controls overall operations of the image data generating apparatus 102 including initial setting, control of various devices, and image data processing. In this example, a CPU of a general-purpose computer or work station is used.

The internal bus 205 connects the devices described above with one another. In this example, a serial bus such as a PCI Express bus is used.

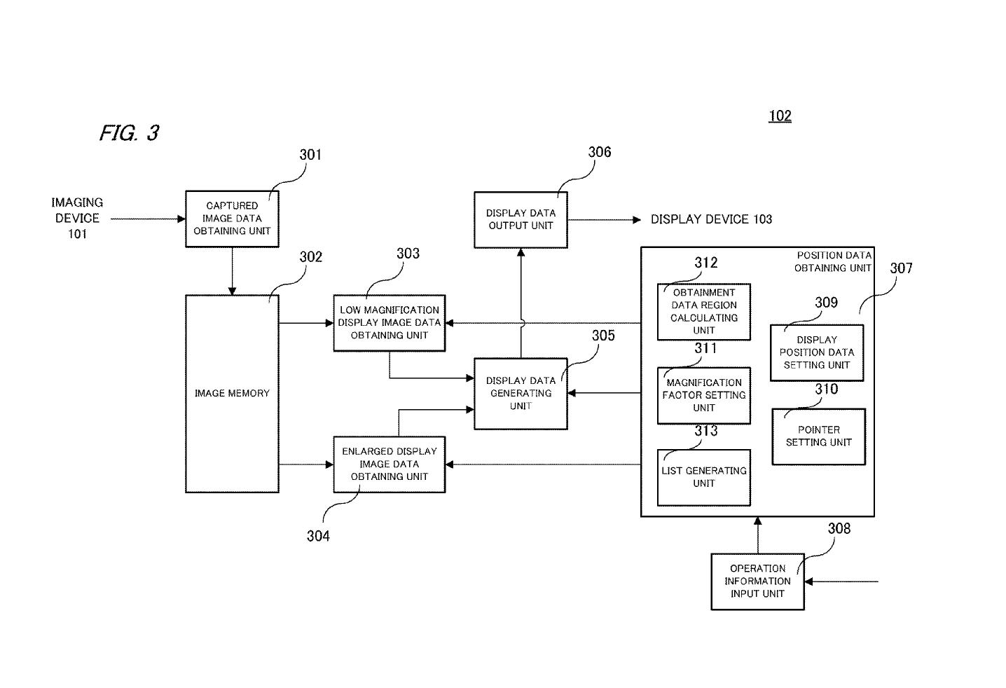

FIG. 3 is a functional block diagram of the image data generating apparatus 102 of the first embodiment of the present invention. The image data generating apparatus 102 shown in FIG. 3 comprises a captured image data obtaining unit 301, an image memory 302, a low magnification display image data obtaining unit 303, an enlarged display image data obtaining unit 304, a display data generating unit 305, a display data output unit 306, a position data obtaining unit 307, and an operation information input unit 308. In addition, the position data obtaining unit 307 comprises a display position data setting unit 309, a pointer setting unit 310, a magnification factor setting unit 311, an obtainment data region calculating unit 312, and a list generating unit 313.

The captured image data obtaining unit 301 has a function of inputting captured image data obtained by the imaging device 101 and outputting the captured image data to the image memory. While a format of inputted captured image data is desirably variable through automatic recognition of the connected imaging device 101 by an imaging device recognizing unit (not shown), the format may be set by a user.

The image memory 302 stores captured image data associated with a positional coordinate. For example, in a case of a captured image with N×N number of pixels, a positional coordinate of a top left pixel of the captured image is defined as (0, 0), a positional coordinate of a pixel adjacent to the right side of the top left pixel is defined as (1, 0), a positional coordinate of a bottom left pixel is defined as (0, N−1), and a positional coordinate of a bottom right pixel is defined as (N−1, N−1). In this case, image data corresponding to each positional coordinate is stored in the image memory 302 as captured image data associated with the positional coordinate. In addition, for example, captured image data is stored in the order described above starting from address number 0 in the image memory 302. Therefore, a positional coordinate in a captured image, a positional coordinate on captured image data, and an address number can be specified on a one-on-one basis. Captured image data stored in the image memory 302 can be black-and-white image data or color image data. Color image data include three pieces of image data corresponding to RGB for each positional coordinate. Moreover, captured image data include a plurality of hierarchical image data, each hierarchical image data corresponds to different observation magnification factors. Therefore, image data corresponding to any positional coordinate on captured image data of any hierarchy can be inputted and outputted by specifying an observation magnification factor and a memory address.

The low magnification display image data obtaining unit 303 obtains image data of a region specified by the position data obtaining unit 307 (to be described later) from the image memory 302.

The enlarged display image data obtaining unit 304 obtains image data of a partial region of a captured image specified by the position data obtaining unit 307 from the image memory 302.

In a case where a specified region is rectangular, the region may be specified using positional coordinates of four corners of the specified region or may be represented by a pair comprising a top left positional coordinate and a bottom right positional coordinate or by a positional coordinate at the head of the region and the numbers of horizontal and vertical pixels (region width).

The display data generating unit 305 has a function of generating data of the display image for displaying image on the display device 103. The data of the display image includes image data of a low magnification display image, an enlarged display image, an entire display image, a pointer image, and a list image. A region or a position of each piece of image data to be displayed on the display device 103 are specified based on information obtained by the position data obtaining unit 307. Moreover, when there is a plurality of regions of interest specified by the user as enlarged display subjects, the display data generating unit 305 generates data for enlarged display which shows enlarged images of these regions. The data of the list image included in the data of the display image corresponds to the first data of the invention. The data of the enlarged display image included in the data of the display image corresponds to the second data of the invention. The data of the entire image included in the data of the display image corresponds to the third data of the invention. The data of the low magnification display image included in the data of the display image corresponds to the fourth data of the invention.

The display data output unit 306 has a function of outputting display data to the display device 103. The display data output unit 306 accommodates various formats of the outputted display data such as an RGB signal and a brightness color-difference signal. In addition, the display data output unit 306 also arbitrarily accommodates a resolution (number of pixels) of the display device 103. While these settings are desirably variable in accordance with recognition of the connected display device 103 by a display device recognizing unit (not shown), the format may also be set by a user.

The operation information input unit 308 has a function of obtaining operation/setting information such as a movement of a mouse pointer, a decision of an operation, and a numerical input operated/set by the user from an operating unit (not shown), and outputting the operation/setting information to the position data obtaining unit 307.

The position data obtaining unit 307 has a function of generating the following data based on operation/setting information such as a movement of a mouse pointer, a decision of an operation, and a numerical input operated/set by the user. Specifically, the position data obtaining unit 307 has a function of generating an obtainment region and a low magnification display magnification factor for low magnification display image data, an obtainment region and an enlarged display magnification factor (an enlargement factor) for enlarged display image data, and list image data. Furthermore, the position data obtaining unit 307 also has a function of generating display regions on the display device 103 of the respective images, pointer image data, and a display positional coordinate on the display device 103 of the pointer image data.

The pointer setting unit 310 partially constitutes the position data obtaining unit 307 and has a function of setting a display positional coordinate of a pointer image (icon) on the display device 103 from pointer movement information and generating pointer image data.

The display position data setting unit 309 partially constitutes the position data obtaining unit 307 and has a function of respectively setting display regions of a low magnification display image, an enlarged display image, and a list image on the display device 103 from numerical information and instructing the display regions to the display data generating unit. In addition, the display region of an enlarged display image on the display device 103 is set such that the display region is modified as appropriate depending on the number of selected regions of interest.

The magnification factor setting unit 311 is a part of functions constituting the position data obtaining unit 307 and has a function of setting a low magnification display magnification factor and an enlarged display magnification factor based on numerical information.

The list generating unit 313 is a part of functions constituting the position data obtaining unit 307 and has a function of obtaining a positional coordinate on captured image data corresponding to a region of interest (also referred to as ROI hereinafter) on a captured image, generating a list associated with an enlarged display magnification factor, and generating list image data. These processes are executed based on mouse pointer decision information, the positional coordinate of the pointer image on the display device 103, and an obtainment region and a low magnification display magnification factor of low magnification display image data. In this case, the obtained positional coordinate of the ROI is a positional coordinate on captured image data corresponding to a representative position in the ROI. The representative position in this example is a positional coordinate at the head of the region. In addition, each item of a list is managed also in association with a display positional coordinate on the display device 103 as well as with the enlarged display magnification factor. The associated positional coordinate is a positional coordinate on the captured image data corresponding to any one of ROI, and is selected according to a display positional coordinate of a pointer image on the display device 103 and decision information.

The obtainment data region calculating unit 312 is a part of functions constituting the position data obtaining unit 307. The obtainment data region calculating unit 312 has a function of calculating an obtainment region of low magnification display image data to generate a low magnification display image. The obtainment data region of low magnification display image is calculated based on a positional coordinate on captured image data, a low magnification display magnification factor, and a display positional coordinate on the display device 103 of a low magnification display image to be displayed. Furthermore, the obtainment data region calculating unit 312 has a function of calculating an obtainment region of enlarged display image data to generate an enlarged display image. The obtainment data region of enlarged magnification display image is calculated based on a positional coordinate on captured image data corresponding to an ROI selected from a list, an enlarged display magnification factor, and a display region of an enlarged display image on the display device 103.

The image data generating apparatus 102 shown in FIG. 3 operates as follows using the functions described above. Specifically, the captured image data obtaining unit 301 inputs captured image data obtained by the imaging device 101 into the image memory 302. The position data obtaining unit 307 calculates a positional coordinate on the captured image data of an image to be displayed in response to an instruction from an operating unit (not shown). Subsequently, the image data obtaining units 303, 304 obtain image data of a region corresponding to the positional coordinate from the image memory 302. The display data generating unit 305 generates display data from obtained image data, and the display data outputting unit 306 outputs the generated display data to the display device 103. In addition, the position data obtaining unit 307 creates a list which associates a positional coordinate on captured image data corresponding to an ROI specified on a display image and with a magnification factor at which the display is to be performed. The list is configured so as to enable selection of a positional coordinate on captured image data of image data to be desirably generated as display data.

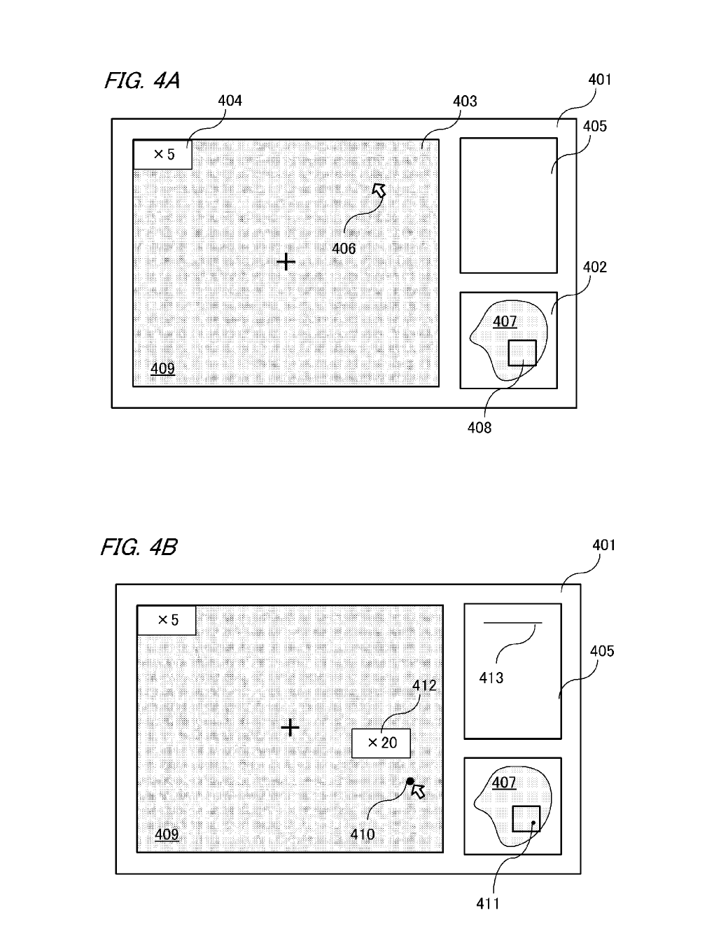

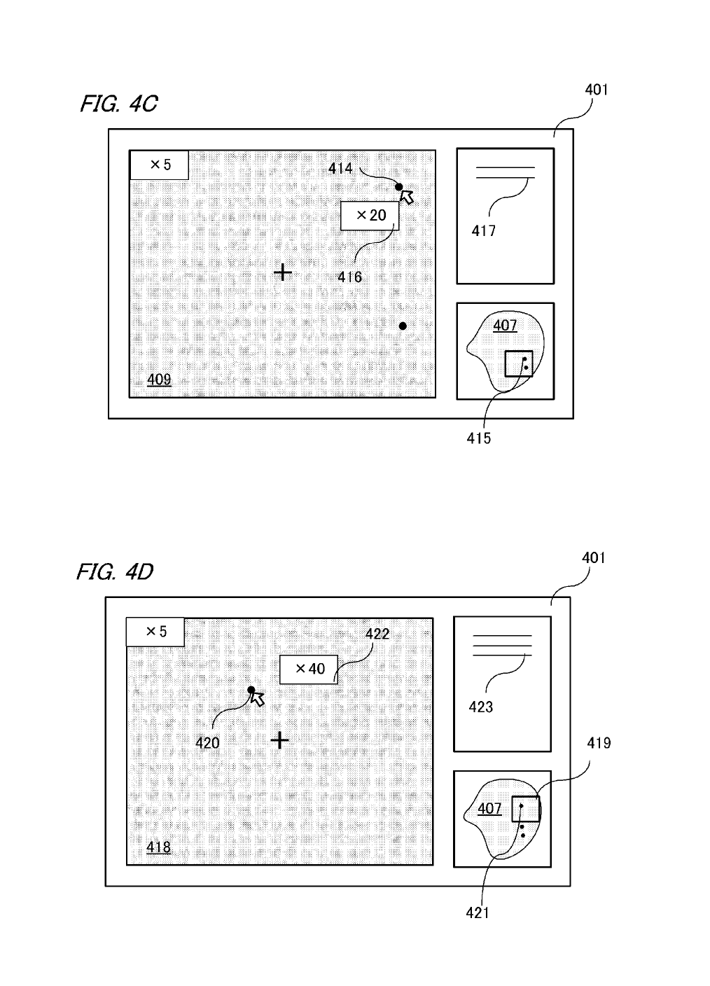

FIGS. 4A to 4D are display screen configuration examples during a screening operation in the first embodiment of the present invention. As shown in FIG. 4A, a display screen 401 of the display device 103 during a screening operation comprises an entire image display section 402, an observation image display section 403, an observation magnification factor display section 404, and a region-of-interest information display section (list display section) 405. A display region on the display device 103 can be arbitrarily set by the user from an operating unit (not shown). In addition, the display screen 401 also displays a pointer image 406 which moves in accordance with pointer movement information from an operating unit (not shown).

In the entire image display section 402, an entire image 407 that is a reduction of whole captured image data obtained from the imaging device 101 and a region defining frame 408 of a display image corresponding to a observation magnification factor displayed in the observation image display section 403 are displayed.

In the observation image display section 403, an observation image (an enlarged image) 409 of a positional coordinate on captured image data specified by the user is displayed at a display magnification factor indicated in the observation magnification factor display section 404.

In the observation magnification factor display section 404, a display magnification factor set by the user is displayed. FIG. 4A shows an example where a display magnification factor of 5 is set.

In the region-of-interest information display section 405, a positional coordinate on captured image data corresponding to a ROI specified/set by the user and a region-of-interest display magnification factor are displayed in a specified/set order. In FIG. 4A, since no ROI has yet been specified, the region-of-interest information display section 405 has an empty field.

A positional coordinate of a ROI is acquired by obtaining position information specified on the observation image 409 and calculating a positional coordinate on captured image data corresponding to the position. In an alternative configuration, a positional coordinate of a ROI can be obtained by directly inputting a value of a positional coordinate on captured image data or a value of a positional coordinate on the display screen 401.

FIG. 4B shows an example of the display screen 401 when a first ROI has been specified from FIG. 4A. A region of interest mark 410 is displayed at a position corresponding to the first ROI on the observation image 409 and a ROI mark 411 is also displayed at a position corresponding to the first ROI on the entire image 407. When a ROI is specified, a region-of-interest display magnification factor input section 412 is displayed for inputting a region-of-interest display magnification factor at which the ROI is desirably observed in detail. FIG. 4B shows an example where a ROI display magnification factor of 20 is set. In addition, in the ROI information display section 405, a ROI display magnification factor for detailed observation together with a positional coordinate on the captured image data of the first ROI obtained at this point are displayed as ROI information 413. Here, a configuration can be adopted, in which the ROI display magnification factor can be selected by the user from a list of candidates prepared in advance. This configuration simplifies screening operation. On the other hand, a configuration that enables direct numerical input may be adopted in order to accept input of any magnification factors. In addition, both of the methods described above may be combined.

FIG. 4C shows an example of the display screen 401 when a second ROI has been further specified from the state shown in FIG. 4B. In a similar manner to FIG. 4B, a ROI mark 414 on a second observation image 409, a ROI mark 415 on the entire image 407, a ROI display magnification factor 416 for detailed observation, and ROI information 417 are updated and displayed.

FIG. 4D shows an example of the display screen 401 when a third ROI has been further specified from the state shown in FIG. 4C. In this case, since it is assumed that a ROI is to be specified after moving the observation image 409 displayed in FIG. 4A, the third ROI is not in a same display region as the first and second ROIs. FIG. 4D shows an example where the third ROI exists at an upper position in the entire image 407. By scrolling the observation image 409 displayed in FIG. 4A upward with an operating unit (not shown), a positional coordinate on the captured image data of the observation image to be displayed is updated and a new observation image 418 is displayed. Alternatively, a configuration may be adopted in which the observation image is updated by moving a region defining frame 419 on the entire image 407 instead of scrolling the observation image 409. In this case, by moving the region defining frame 419 on the entire image 407 displayed in FIG. 4A upward in response to an instruction from an operating unit (not shown), a positional coordinate on captured image data of the observation image to be displayed is updated and the observation image 318 is displayed. Still alternatively, a configuration may be adopted in which a value of a positional coordinate on captured image data is directly inputted. In addition, the region defining frame 419 is displayed on the entire image 407 at a position corresponding to a display region of a new observation image 418. Furthermore, in a similar manner to FIG. 4C, a ROI mark 420 on the third observation image 418, a ROI mark 421 on the entire image 407, a ROI display magnification factor 422 for detailed observation, and ROI information 423 are updated and displayed. FIG. 4D shows an example where a ROI display magnification factor for detailed observation of 40 is inputted and specified.

During a screening operation, the display operations described above are repeated until all ROIs are specified. Accordingly, a plurality of ROIs can be specified in a simple and intensive manner.

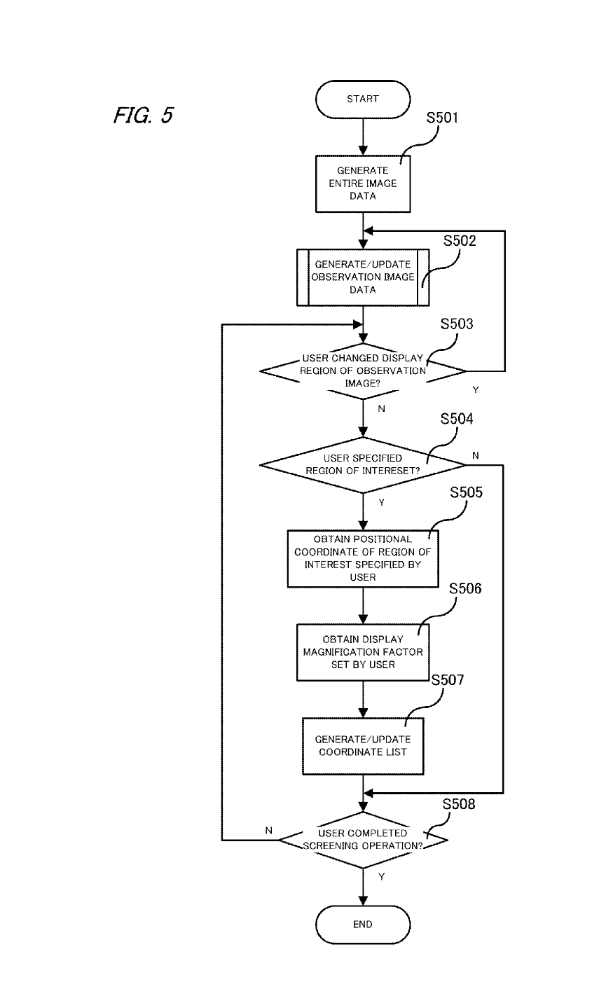

FIG. 5 is a flow chart of display data generation during a screening operation in the first embodiment of the present invention.

In step S501, the display data generating unit 305 generates display data for displaying the entire image 407 in the entire image display section 402. Entire image data is generated by reading out captured image data from the image memory 302 and converting resolutions to conform to the display region of the entire image display section 402. Moreover, processing speed for displaying the entire image 407 can be increased by preparing the data for display after resolution conversion in advance.

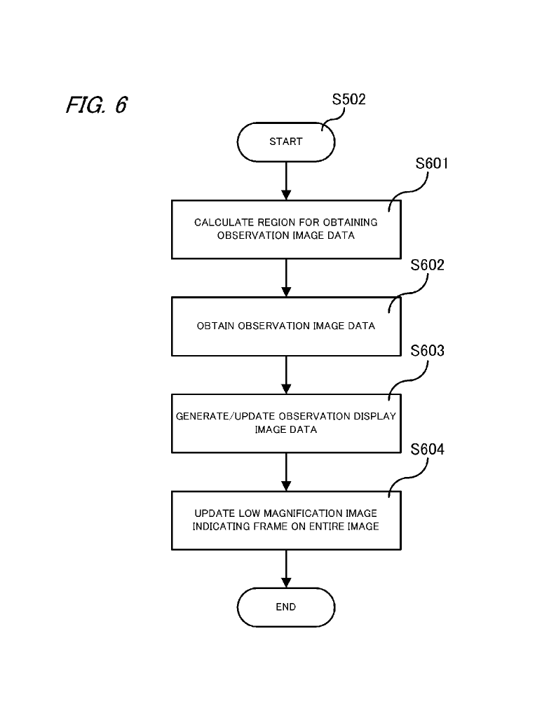

Next, in step S502, the low magnification display image data obtaining unit 303 read out image data of a region of the observation image to be displayed from the image memory 302, and the display data generating unit 305 generates observation image data for display in the observation image display section 403. Details of this step will be described later with reference to FIG. 6. As a result, display data for display as shown in FIG. 4A is generated. Moreover, when modifying the display region of the observation image in response to a result of step S503 (which will be described below), new observation image data is generated and updated.

Next, in step S503, a determination is made regarding whether or not the display region of the observation image has been modified. If modified, the process returns to step S502 to update display data. If the display region has not been modified, the process proceeds to step S504.

In step S504, a determination is made regarding whether or not a region of interest has been specified by the user. If a ROI has not been specified, the process proceeds to step S508, and if it has been specified, the process proceeds to step S505.

Next, in step S505, the position data obtaining unit 307 obtains a positional coordinate on captured image data corresponding to the ROI specified by the user.

Next, in step S506, the position data obtaining unit 307 obtains a ROI display magnification factor set by the user for detailed observation of the region of interest specified in step S505. Alternatively, a configuration may be adopted in which an adequate value is set as a default value and the default value is used with or without modification. For example, when performing screening using an observation image at a magnification factor of 5 to 10, the default magnification value for detailed observation may be set as a magnification factor of 20, and the default value may be used if no particular modification is made. Only when observation must be performed at a magnification factor of other than 20 (for example, 40), an user need to set a ROI display magnification factor of 40 for such ROI.

Next, in step S507, the list generating unit 313 generates a list which associates a positional coordinate on captured image data and a region-of-interest display magnification factor of the obtained ROI. The display data generating unit 305 generates list image data such that each item in the list is additionally displayed in the ROI information display section 405 in a specified order, and display data is generated or updated. As a result, the display data shown in FIG. 4B is generated.

Next, in step S508, a determination is made regarding whether or not the screening operation has been completed. If the screening operation has been completed or, in other words, if a transition has been made to a next detailed observation at a high magnification or a read-in instruction of another object image has been issued in order to start a screening operation on another object, the present processing for display data generation is terminated. If it is determined that the screening operation is ongoing, the process returns to step S503 to enter a stand-by state for modifying a display region of the observation image.

Here, a configuration may be adopted in which a list created as described above is stored in the storage 202. Alternatively, a configuration may be adopted in which the list is outputted to the outside of the apparatus via the I/F 203. Furthermore, desirably, the list can be managed in association with a captured image data file. This association may be performed by describing information regarding a captured image data file in the list or by describing information on the list in a captured image data file.

By enabling the list to be stored/outputted in this manner, information on a ROI obtained in the screening operation can be shared by another user. At the same time, information of a ROI obtained in a previous screening operation can be used.

FIG. 6 is a flow chart of a step of generating or updating observation image data during a screening operation.

In S601, the obtainment data region calculating unit 312 calculates a region for obtaining observation image data based on a positional coordinate on captured image data, a display magnification factor for observation, and a display region of the observation image display section 403 on the display device 103. For example, let us consider a case where captured image data is constituted by hierarchical image data corresponding to magnification factors of 5, 10, 20, and 40. When a display magnification factor for observation which the user wishes to use for display is 5, a region for obtaining observation image data is calculated from hierarchical image data corresponding to a magnification factor of 5. In this case, based on a positional coordinate on the captured image data of the observation image which the user wishes to display, a region with the same number of pixels as the display region of the observation image display section 403 becomes a region of observation image data to be obtained. Meanwhile, when a display magnification factor for observation which the user wishes to use for display is 8, a region for obtaining observation image data is calculated from hierarchical image data corresponding to a magnification factor of 10. In this case, based on the positional coordinate on the captured image data of the observation image which the user wishes to display, a region having 10/8 times the number of pixels of the display region of the observation image display section 403 becomes a region of observation image data to be obtained.

Next, in S602, the low magnification display image data obtaining unit 303 reads out image data corresponding to the calculated region from the image memory 302.

Next, in S603, the display data generating unit 305 generates or updates observation display image data to prepare display data. At this point, when a display magnification factor indicated by a hierarchy in which the observation image data obtained in step S602 had been stored differs from a display magnification factor at which display is actually performed in the observation region, image data is processed so that display can be performed at a desired display magnification factor by resolution conversion. In the example described above where a display magnification factor for observation which the user wishes to use for display is a magnification factor of 8, resolution conversion is performed at a factor of 8/10.

Lastly, in S604, a region defining frame corresponding to a region of the observation image which the user wishes to display is generated on the entire image data and display data is generated or updated. Moreover, since the position of the region defining frame can be obtained upon calculation of a region of observation image data in step S601, updating can be performed at a subsequent arbitrary timing.

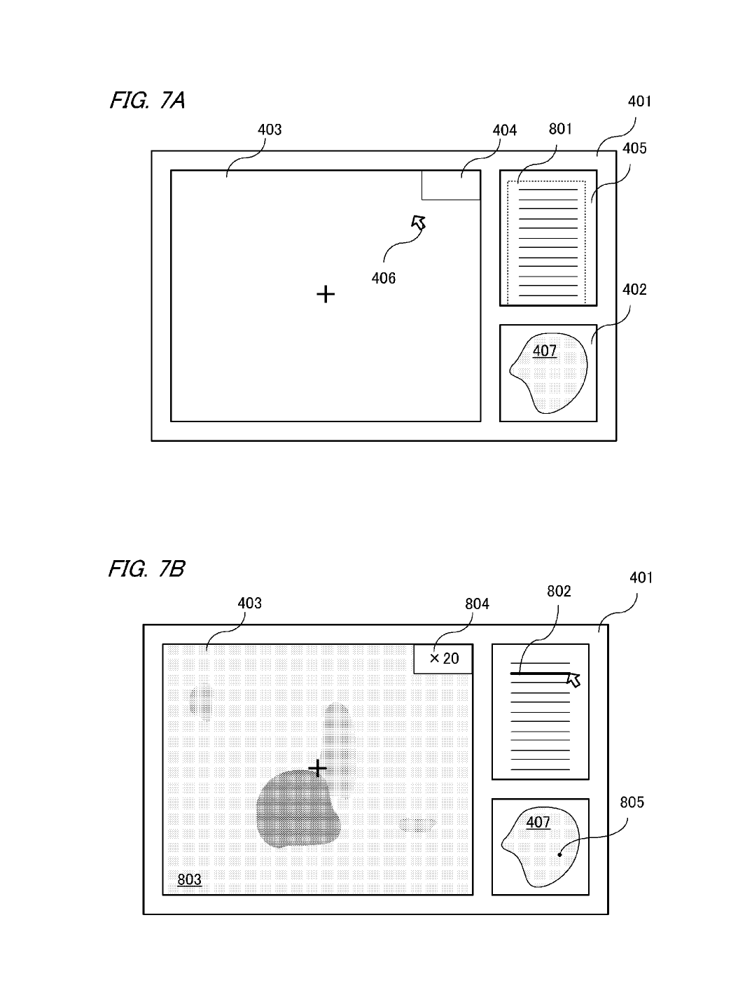

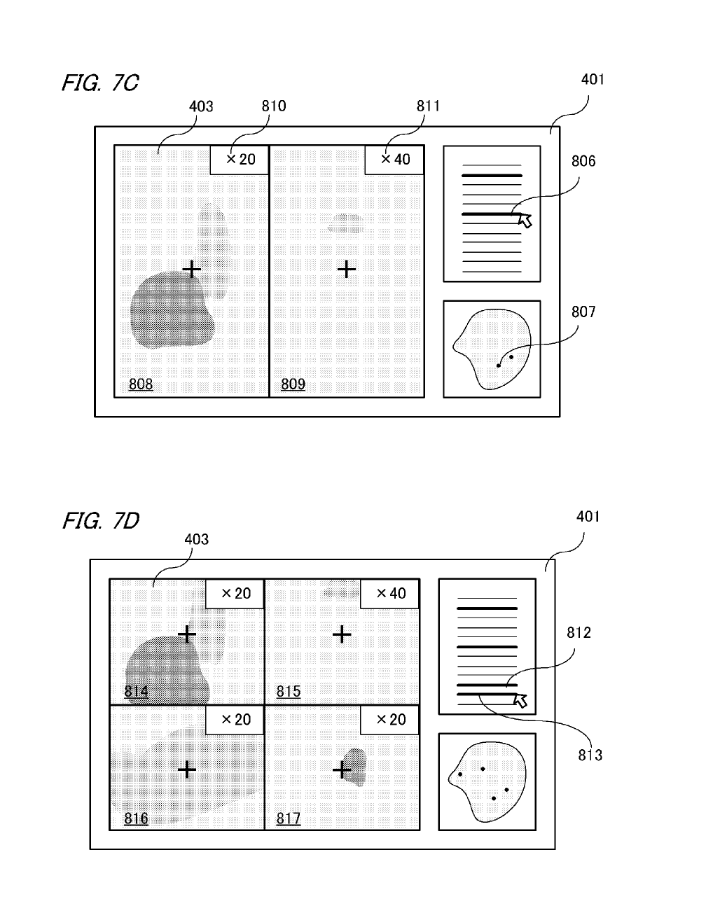

FIG. 7 is an example of a display screen configuration during detailed observation in the first embodiment of the present invention.

As shown in FIG. 7A, in a similar manner to FIG. 4, the display screen 401 of the display device 103 during detailed operation comprises the entire image display section 402, the observation image display section 403, the observation magnification factor display section 404, and the region-of-interest information display section 405. A display region on the display device 103 can be arbitrarily set by the user from an operating unit (not shown). In addition, the display screen 401 also displays a pointer image 406 which moves in accordance with pointer movement information from an operating unit (not shown). Furthermore, the entire image 407 that is a reduction of whole captured image data obtained from the imaging device 101 is displayed in the entire image display section 402.

The observation image display section 403 displays an enlarged display image of a region corresponding to a ROI selected from a list by the user. FIG. 7A shows a state where nothing is displayed because a ROI has not yet been selected. Alternatively, a configuration may be adopted in which a low magnification image at a magnification factor of around 10 which had been displayed during screening is displayed.

A ROI display magnification factor for detailed observation for a ROI selected from a list by the user is displayed in the observation magnification factor display section 404. FIG. 7A shows an empty field because a ROI has not yet been selected. Alternatively, a magnification factor of 10 is displayed when a low magnification image at a magnification factor of around 10 which had been displayed during screening is displayed.

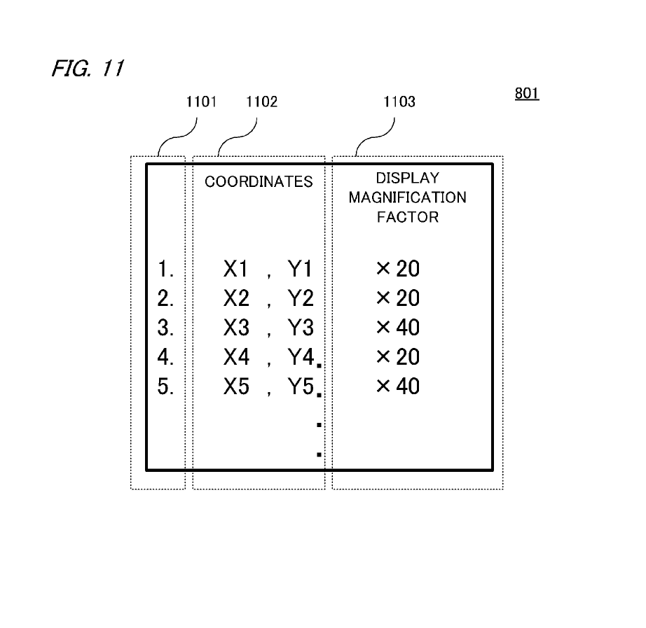

A list 801 of ROIs generated during screening is displayed in the region-of-interest information display section 405. For example, the list 801 is displayed in a format shown in FIG. 11 (to be described later). The user is able to select a region which the user wishes to observe in detail from the displayed list 801 of ROIs. Besides selecting a ROI from the list 801 and displaying the ROI, a configuration may be adopted in which a display positional coordinate of each item or a ROI display magnification factor for detailed observation can be directly inputted and displayed based on information displayed as a list.

FIG. 7B shows an example of the display screen 401 in which a first ROI has been selected from FIG. 7A. An item 802 corresponding to the first ROI selected on the list 801 is highlighted. In addition, an enlarged display image 803 corresponding to the selected first ROI is displayed in the observation image display section 403 at a corresponding ROI display magnification factor. Moreover, a ROI display magnification factor is a display magnification factor for detailed observation stored together when creating a list of ROIs. In this case, since only one ROI has been selected, the first enlarged display image 803 is displayed using an entire display region of the observation image display section 403. In addition, a ROI display magnification factor 804 for detailed observation of the first ROI is displayed in the observation magnification factor display section 404. FIG. 7B shows an example where the display magnification factor is 20. Furthermore, a selected region mark 805 is displayed at a position corresponding to the first ROI on the entire image 407.

FIG. 7C shows an example of the display screen 401 in which a second ROI has been selected from FIG. 7B. From FIG. 7B, an item 806 corresponding to the second ROI on the list 801 is further highlighted and a second ROI mark 807 has been added and displayed on the entire image 407. Meanwhile, enlarged display images 808 and 809 corresponding to the first and second ROIs are displayed in the observation image display section 403 at respectively corresponding ROI display magnification factors. In this case, since two ROIs have been selected, the respective enlarged display images are displayed by dividing the entire display region of the observation image display section 403 into halves. In addition, the observation magnification factor display section 404 is displayed on each enlarged display image region and respective ROI display magnification factors 810 and 811 are displayed in each observation magnification factor display section 404.

FIG. 7D shows an example of a display screen in which two ROIs have been further selected from FIG. 7C. In a similar manner to FIG. 7C, items 812 and 813 corresponding to the third and fourth ROIs on the list 801 are additionally highlighted and a total of four selected region marks on the entire image 407 are displayed. Meanwhile, enlarged display images 814, 815, 816, and 817 corresponding to the first to fourth ROIs are displayed in the observation image display section 403 at respectively corresponding ROI display magnification factors. In this case, each enlarged display image is displayed by dividing the entire display region of the observation image display section 403 into quarters. In addition, the observation magnification factor display section 404 is displayed on each observation image display section 403 and respective ROI display magnification factors are displayed in each observation magnification factor display section 404.

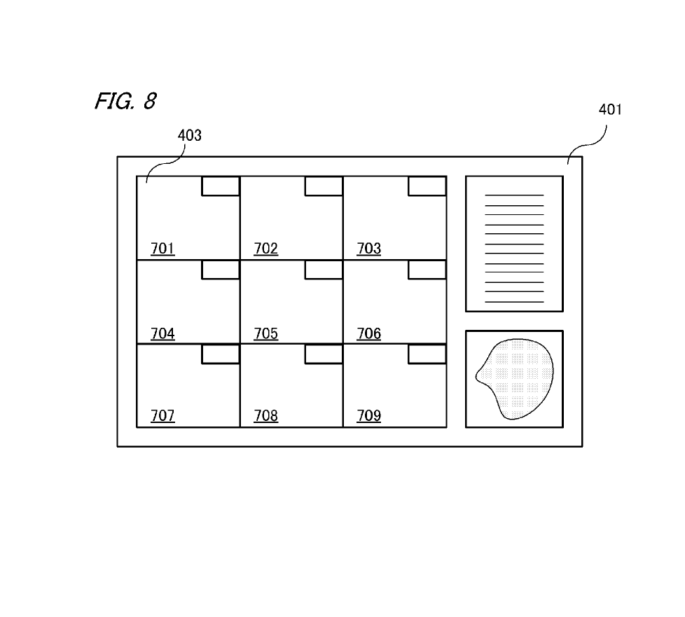

A display mode of enlarged images is not limited to the above and an arbitrary method can be adopted. For example, a configuration may be adopted in which an enlarged display image is displayed as shown in FIG. 8. Specifically, the observation image display section 403 of the display screen 401 is divided according to the number of divisions and an arrangement set in advance to constitute divided regions 701 to 709. In addition, a display order is determined in advance for each divided region and enlarged display images of ROIs selected from the list 801 are displayed in a selected order based on the display order of the divided regions. Another configuration may be adopted in which a divided region for displaying an enlarged display image is sequentially set upon selection of a ROI.

When performing a detailed observation, the display operations described above are repeated in response to a selection of a ROI by the user and detailed observations of a plurality of ROIs can be carried out simultaneously. By arranging and displaying ROIs specified and selected during screening in a plurality of display regions as described above, a user can now concentrate on detailed diagnosis including comparing observation objects.

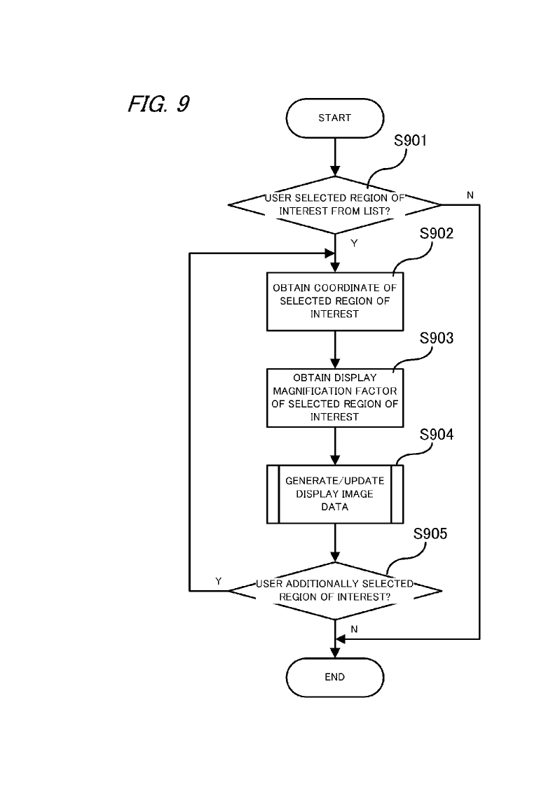

FIG. 9 is a flow chart for describing generation of display image data during detailed observation for describing the first embodiment of the present invention.

First, in step S901, the position data obtaining unit 307 determines whether or not the user has selected any ROI from the generated ROI list. If a ROI has been selected, the process proceeds to step S902. If no ROI has been selected, the present process for generating display image data for detailed observation is terminated.

Next, in step S902, the position data obtaining unit 307 obtains a positional coordinate on captured image data corresponding to the ROI selected by the user from the list.

Next, in step S903, the position data obtaining unit 307 obtains a ROI display magnification factor corresponding to the ROI selected by the user from the list.

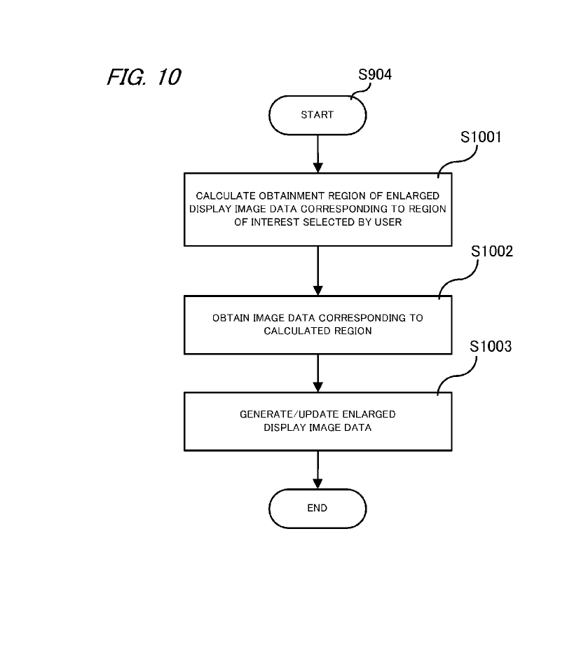

Next, in S904, The enlarged display image data obtaining unit 304 reads out image data corresponding to a region of an enlarged display image selected by the user from the image memory 302. Subsequently, the display data generating unit 305 generates observation image data that is displayed in enlargement. Details of this step will be described later with reference to FIG. 10.

Finally, in step S905, a determination is made regarding whether or not a ROI has been additionally selected. If an additional selection has been made, the process returns to step S902 to subsequently repeat generation of enlarged display image data for detailed observation. If no additional selections have been made, the present process for generating display image data for detailed observation is terminated. Image data generated in this manner is used to display a screen for detailed observation shown in FIG. 7D.

While a list created during a screening operation and stored in the memory 201 is used as the list that is presented to the user to have the user select any ROI, a configuration may be adopted in which information stored in the storage 202 is read out. Alternatively, a configuration may be adopted in which the list is inputted from the outside of the apparatus via the I/F 203. Furthermore, a configuration is desirably adopted in which captured image data is inputted again when the captured image data stored in the memory 201 is not consistent with the captured image data associated with the list.

By enabling the list to be read out/inputted in this manner, another user can perform detailed observation using information on a ROI obtained in a screening operation. At the same time, detailed observation can be performed using information of a ROI obtained in a previous screening operation.

FIG. 10 is a flow chart of step S904 for generating/updating an enlarged display image in the detailed observation flow. The display data generating unit 305 generates/updates an enlarged display image for displaying an enlargement of a region-of-interest selected by a user. Each enlarged display image is displayed at a display magnification factor corresponding to the region of interest included in each enlarged image. More specifically, each enlarged display image is displayed at a magnification (or resolution, scale of enlargement) on the basis of a display magnification factor corresponding to the region of interest included in each enlarged image.

In step S1001, the obtainment data region calculating unit 312 calculates a region of enlarged display image data to be obtained for detailed observation which corresponds to a ROI selected by the user. This region is calculated based on a positional coordinate on captured image data corresponding to a ROI selected by the user, a ROI display magnification factor for detailed observation, and a display region of an enlarged display image on the display device 103. For example, let us consider a case where captured image data is constituted by hierarchical image data corresponding to magnification factors of 5, 10, 20, and 40. When a ROI display magnification factor for detailed observation corresponding to the ROI selected by the user is 20, a region for obtaining enlarged display image data is calculated from hierarchical image data corresponding to a magnification factor of 20. In this case, based on the positional coordinate on the captured image data corresponding to the ROI selected by the user, a region with the same number of pixels as the display region of the enlarged display image in the observation image display section 403 becomes a region of enlarged display image data to be obtained. Meanwhile, when a ROI display magnification factor for detailed observation corresponding to the ROI selected by the user is 35, a region for obtaining enlarged display image data is calculated from hierarchical image data corresponding to a magnification factor of 40. In this case, based on the positional coordinate on the captured image data corresponding to the ROI selected by the user, a region having 40/35 times the number of pixels of the display region of the enlarged display image in the observation image display section 403 becomes a region of enlarged display image data to be obtained. In this case, the display region of the enlarged display image on the display device 103 is calculated based on an entire display region stored as the observation image display section 403 and the number of selected ROIs. Specifically, a display region of an observation image is divided by the number of selected ROIs and regions are set accordingly for image data to be obtained. In addition, when the number of selected ROIs is modified, a region for which each piece of enlarged display image data is obtained is recalculated according to the number of selections made.

Next, in S1002, the enlarged magnification display image data obtaining unit 304 reads out image data corresponding to the calculated region from the image memory 302.

Finally, in S1003, the display data generating unit 305 generates or updates enlarged display image data. Moreover, when a display magnification factor indicated by a hierarchy in which the enlarged display image data obtained in step S1002 had been stored differs from a display magnification factor at which display is actually performed in the observation region of the enlarged display image, image data is processed so that display can be performed at a desired display magnification factor by resolution conversion. In the example described above where a region-of-interest display magnification factor for detailed observation corresponding to the region of interest selected by the user is 35, resolution conversion is performed at a factor of 35/40. In addition, when enlarged display image data has already been obtained, reconstruction may be performed from generated image data for display without obtaining image data once again.

Moreover, while the method of obtaining image data for display described thus far is premised on hierarchical image data being stored in the image memory 302, a configuration may be adopted in which a region is calculated and obtained as appropriate from original captured image data.

FIG. 11 is an example of a format of a list of regions of interest that is generated during screening.

As shown in FIG. 11, a list 801 of ROIs generated during screening is constituted by, for each item, an item number field 1101, a region-of-interest coordinate field 1102, and a region-of-interest display magnification factor field 1103.

In the item number field 1101, a serial number is generated and described in the order in which the ROIs have been obtained. A configuration may be adopted in which this number is displayed instead of the ROI mark shown in FIG. 4. In addition, alphabetical characters or graphics which enable items to be distinguished from one another may be used instead of numbers.

In the ROI coordinate field 1102, a positional coordinate on captured image data corresponding to an obtained ROI is described in association with an item number.

In the ROI display magnification factor field 1103, a ROI display magnification factor corresponding to an obtained ROI is described in association with an item number.

In addition, although not displayed as a list image, each item's display positional coordinates on the display device 103 is stored in association with the item number, so that an item can be selected on the display device 103 using a mouse pointer.

According to the configuration and operations of the first embodiment described above, the user can specify a plurality of regions of interest in a simple and intensive manner during a screening operation for pathological diagnosis. In addition, during detailed observation, a plurality of regions of interest can be simultaneously observed in detail. As a result, a screening operation and detailed observation can be performed independently and work efficiency of pathological diagnosis can be improved. Furthermore, since a correspondence relationship with detailed observation magnification factors can also be comprehended, sizes of subjects (for example, a cell nucleus and the like) can be readily compared when simultaneously displaying a plurality of detailed observation images and work efficiency can be improved.

### Second Embodiment

A second embodiment which realizes the present invention will now be described with reference to the drawings.

In the first embodiment of the present invention, image data for detailed observation is generated based on a region-of-interest display magnification factor obtained during a screening operation. In the present embodiment, modification of an image region or a display magnification factor is made possible during detailed observation, thereby generating image data that can further improve work efficiency of pathological diagnosis.

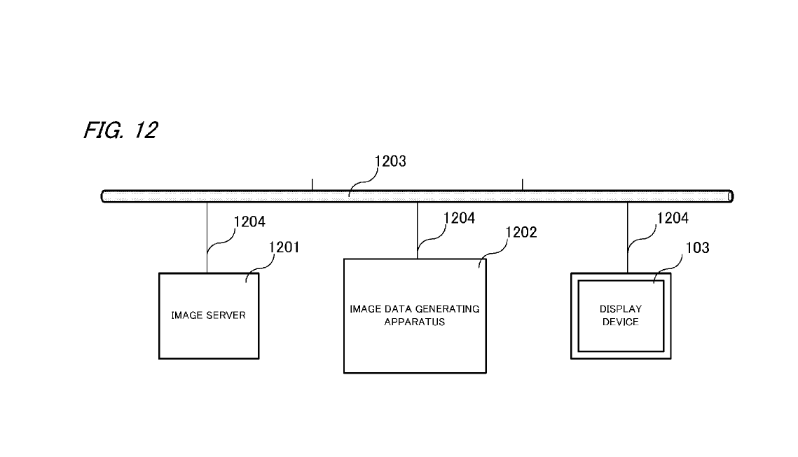

FIG. 12 is a configuration diagram of an image processing system including an image data generating apparatus of the second embodiment of the present invention.

The system shown in FIG. 12 comprises an image server 1201, an image data generating apparatus 1202, and a display device 103. The system has a function of obtaining and displaying a two-dimensional image of a test object (a test sample). The image server 1201, the image data generating apparatus 1202, and the display device 103 are connected to one another by a general-purpose LAN cable 1204 via a network 1203. Alternatively, the connections between the image server 1201 and the image data generating apparatus 1202 and/or between the image data generating apparatus 1202 and the display device 103 may be implemented by using a general-purpose I/F cable such as those denoted by reference numerals 104 and 105 in FIG. 1.

The image server 1201 has a function of saving two-dimensional image data of the test object captured by the imaging device 101 which is capable of capturing two-dimensional images.

The image data generating apparatus 1202 has a function of obtaining captured two-dimensional image data based on the image server 1201 to generate image data and display data suitable for pathological diagnosis.

The image data generating apparatus 1202 and the display device 103 have functions described in the first embodiment in addition to those described above. However, a description of such functions will not be repeated here.

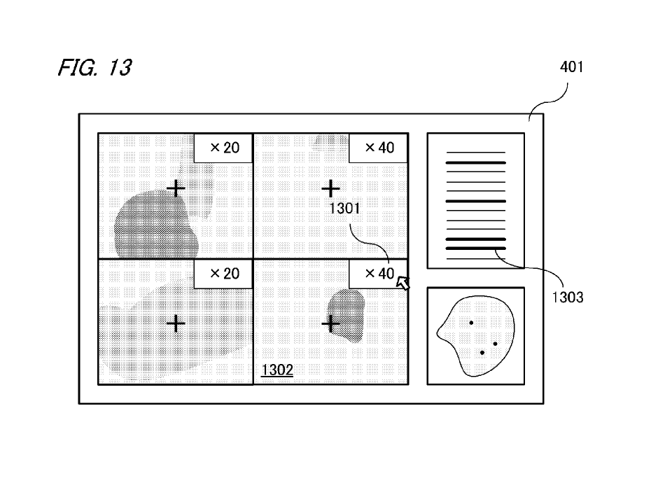

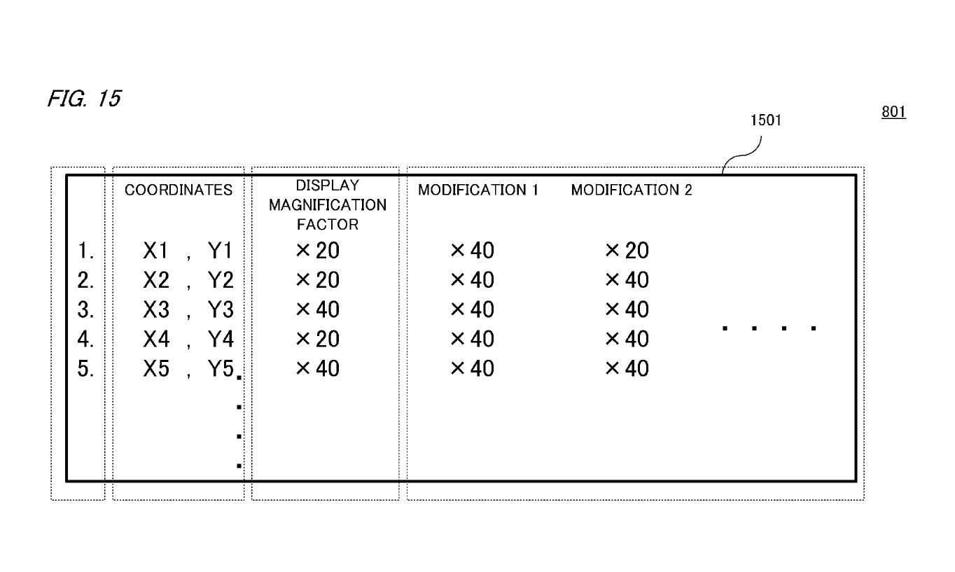

FIG. 13 is an example of a display screen configuration during detailed observation in the second embodiment of the present invention. FIG. 13 shows a state where a region-of-interest display magnification factor 1301 displayed in an observation magnification factor display section at bottom right of the display screen 401 shown in FIG. 7D is modified from 20 to 40. In addition, an enlarged display image 1302 displayed in a bottom-right enlarged display image region is displayed at a magnification factor that is modified in tandem with the modified ROI display magnification factor 1301. Furthermore, an item 1303 which is displayed in a list 801 and which corresponds to the modification described above is also updated and displayed. The list 801 is revised in a format such as shown in FIG. 15 (to be described later), and displayed. Other display configurations and layouts are similar to those shown in FIG. 7D and a description thereof will be omitted. Moreover, instead of a configuration in which a display magnification factor of an individual ROI can be modified, a configuration may be adopted in which a setting unit for collectively modifying a plurality of ROI display magnification factors is prepared so that a plurality of enlarged display images can be collectively updated and displayed. Alternatively, a configuration may be adopted in which a ROI display magnification factor is specified as an increase/decrease instead of by inputting a magnification factor value.

On the other hand, if an image region has been modified instead of a magnification factor, updating and displaying similar to those described above are performed based on the modified image region with the exception of magnification factor.

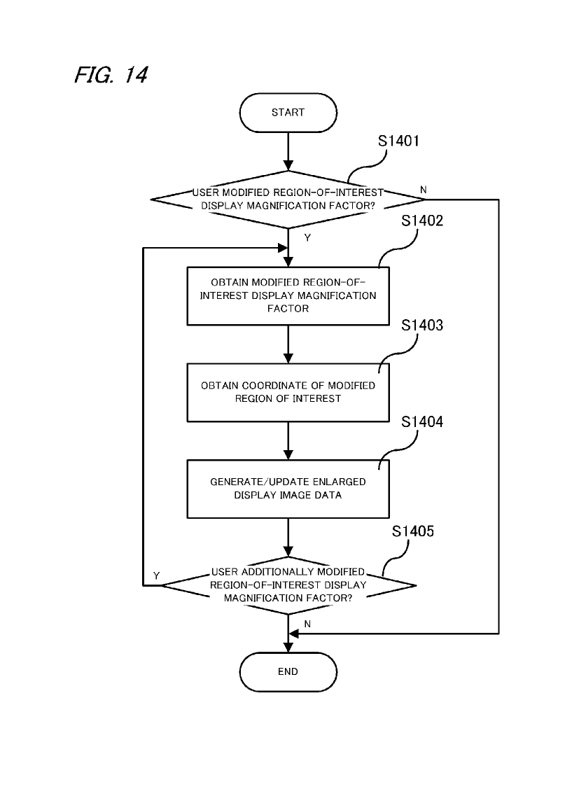

FIG. 14 is a flow chart for describing generation of display image data during detailed observation in the second embodiment of the present invention.

First, in step S1401, a determination is made regarding whether or not the user has modified a ROI display magnification factor. If the ROI display magnification factor has been modified, the process proceeds to step S1402. If not, the present processing for generating display image data for detailed observation is terminated.

Next, in step S1402, the ROI display magnification factor modified by the user is obtained from a list.

Next, in step S1403, a positional coordinate corresponding to the ROI display magnification factor modified by the user is obtained from the list.

Next, in S1404, image data corresponding to a region of an enlarged display image selected by the user is read out from the image memory 302 via the enlarged display image data obtaining unit. Subsequently, observation image data that is displayed in enlargement is generated. Since details of this step are similar to FIG. 10, a description thereof will be omitted.

Finally, in step S1405, a determination is made regarding whether or not a ROI display magnification factor has been additionally modified. If an additional selection has been made, the process returns to step S1402 to subsequently repeat generation of enlarged display image data for detailed observation. If no additional selections have been made, the present processing for generating display image data for detailed observation is terminated.

On the other hand, if an image region has been modified instead of a magnification factor, operations similar to those described above are performed based on the modified image region.

FIG. 15 is an example of a format of a list of modified regions of interest.

As shown in FIG. 15, a list 801 of ROIs is configured such that a modification history field 1501 is added to the format example shown in FIG. 11.

In the modification history field 1501, ROI display magnification factors modified by the user are added in their order of update on an upper right side of FIG. 15. While same information is added for items not modified in this example, fields may alternatively be left blank.

On the other hand, if an image region has been modified instead of a magnification factor, a positional coordinate after modification on captured image data corresponding to the image region is added.

According to the configuration and operations of the second embodiment described above, the user can modify an image region or a display magnification factor during detailed observation in pathological diagnosis while comprehending a correspondence relationship. As a result, sizes of test objects (for example, a cell nucleus and the like) can be more readily compared when simultaneously displaying a plurality of detailed observation images and work efficiency can be improved.

### Third Embodiment

A third embodiment which realizes the present invention will now be described with reference to the drawings.

In the first embodiment of the present invention, image data for detailed observation is generated based on a region-of-interest display magnification factor obtained during a screening operation. In the second embodiment of the present invention, an image region or a display magnification factor can be modified during detailed observation. In the present embodiment, a difference in display magnification factors among a plurality of enlarged display images is made readily comprehensible by the user during detailed observation, thereby generating image data that can further improve work efficiency of pathological diagnosis.

Since an apparatus configuration can be realized in a similar manner to those described in the first and second embodiments, a description thereof will be omitted.

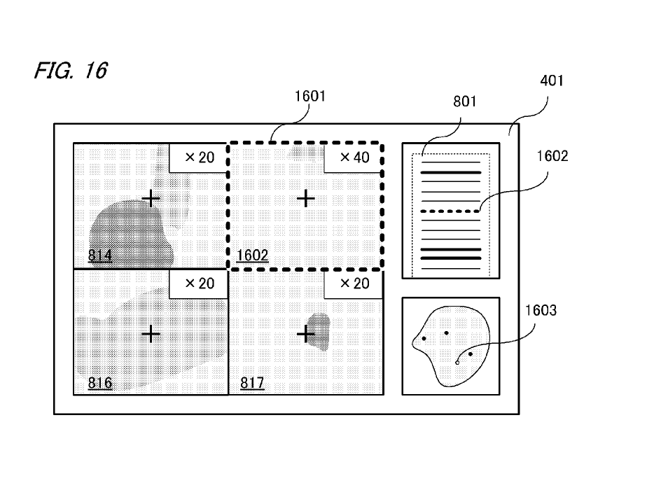

FIG. 16 is an example of a display screen configuration during detailed observation in the third embodiment of the present invention. In FIG. 16, in order to clearly indicate that a display magnification factor of a top-right display region differs from display magnification factors of other display regions in the display screen 401 in the state shown in FIG. 7D, a display mode of a frame 1601 of the top-right display region is differentiated from display mode of frames of other display regions. While the frame 1601 is depicted by a dotted line in FIG. 16, in reality, a display color of the frame 1601 can conceivably be differentiated from display colors of other frames. In addition, preferably, in association with the display color of the frame 1601, a highlighted display color of a corresponding item 1602 and a display color of a selected region mark 1603 on the entire image 407 are also modified. By differentiating the display color of the frame 1601, the user can more readily determine that the display magnification factor of the enlarged display image 1602 differs from those of other enlarged display images 814, 816, and 817. A display color of a frame is set in advance per magnification factor by the user. Alternatively, a configuration may be adopted in which a display color is set when specifying a region-of-interest display magnification factor during a screening operation. Still alternatively, a configuration may be adopted in which a display color is set during detailed observation. In addition, a configuration may be adopted in which display magnification factors can be distinguished from each other by a display brightness of a frame, a shape of a frame, a display color/display brightness of an observation magnification factor display section, a display color/display brightness of a region-of-interest display magnification factor, or the like instead of by a frame display color. Furthermore, a configuration may be adopted in which all of the items of the list 801 are colored in display colors for each set magnification factor according to region-of-interest display magnification factors described in the items.

According to this configuration, determination of a ROI display magnification factor from the list in a ROI selection step can be made even more readily.

Other display configurations and layouts are similar to those shown in FIG. 7D and a description thereof will be omitted.

According to the configuration and operations of the third embodiment described above, the user can determine a difference in display magnification factors among a plurality of enlarged display images during detailed observation in pathological diagnosis while comprehending a correspondence relationship. As a result, sizes of subjects (for example, a cell nucleus and the like) can be more readily compared when simultaneously displaying a plurality of detailed observation images and work efficiency can be improved.

### Fourth Embodiment

A fourth embodiment which realizes the present invention will now be described.

In the first embodiment of the present invention, image data for detailed observation is generated based on a region-of-interest display magnification factor obtained during a screening operation. In the second embodiment of the present invention, an image region or a display magnification factor can be modified during detailed observation to. Furthermore, in the third embodiment of the present invention, a difference in display magnification factors among a plurality of enlarged display images is made readily comprehensible by the user during detailed observation. In the present embodiment, region-of-interest information having a same condition can be collectively selected among region-of-interest information obtained at a screening operation and displayed during detailed observation, thereby generating image data that can further improve work efficiency of pathological diagnosis.

Since an apparatus configuration can be realized in a similar manner to those described in the first and second embodiments, a description thereof will be omitted.

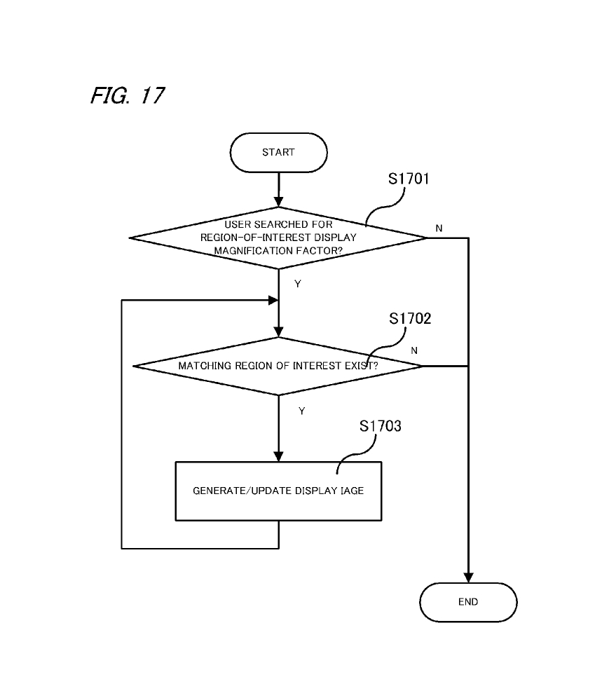

FIG. 17 is a flow chart for describing generation of display image data during detailed observation in the fourth embodiment of the present invention.

First, in step S1701, a determination is made regarding whether or not the user has searched for a ROI display magnification factor. If a specific ROI display magnification factor has been searched, the process proceeds to step S1702. If not searched, the present processing for generating display image data for detailed observation is terminated.

Next, in step S1702, a determination is made on whether or not there is a ROI that conforms to the specific ROI display magnification factor searched by the user from the list. If there is a matching ROI, the process proceeds to step S1703. If there is no matching ROI, the present processing for generating display image data for detailed observation is terminated.

Next, in step S1703, a positional coordinate corresponding to the ROI matched the search is obtained. In addition, image data corresponding to a region of an enlarged display image matched the search is read out from the image memory 302 via the enlarged display image data obtaining unit. Subsequently, observation image data that is displayed in enlargement is generated, and a return is made to step S1702 to subsequently repeat searches for enlarged display image data for detailed observation. Details of these steps are similar to those of S902 to S904 and a description thereof will be omitted.

Moreover, a positional range can be specified as a search condition instead of a magnification factor. In this case, a ROI positioned within a region specified as a search condition is selected and an enlarged display image of the ROI matched the search is generated/displayed. Since contents of processing are basically similar to those described above, a detailed description will be omitted.

According to the configuration and operations of the fourth embodiment described above, the user can collectively select/display ROI information with a same condition from ROI information obtained when performing a screening operation during detailed observation for pathological diagnosis. As a result, sizes of subjects (for example, a cell nucleus and the like) can be more readily compared when simultaneously displaying a plurality of detailed observation images and work efficiency can be improved.

### Fifth Embodiment

The present invention can be implemented as a program code itself of software that realizes all of or a part of the functions of the embodiments described above or as a recording medium (or a storage medium) on which the program code is recorded. The functions described above can be realized by supplying a program code having the functions described above to a system or an apparatus via recording medium storing and having a computer (a CPU or an MPU) of the system or the apparatus read out and execute the program code stored in the recording medium. In this case, the program code itself read out from the recording medium realizes the function of the embodiments described above and the recording medium on which the program code is recorded is to constitute the present invention. Alternatively, the functions described above can be realized by supplying the program code to a system or an apparatus via a network, storing the program code in an auxiliary storage device, and having the system or the apparatus read out and execute the program code stored in the auxiliary storage device.

In addition, the present invention also includes cases where the functions of the embodiments described above are realized by processing performed by an operating system (OS) or the like which runs on a computer and which performs a part or all of the actual processing when the computer executes the read program code.

Furthermore, the present invention also includes cases where a program code read out from a recording medium is written into a memory built into an expansion card inserted into a computer or an expansion unit connected to the computer, a CPU or the like built into the expansion card or the expansion unit subsequently performs a part or all of the actual processing based on instructions of the program code, and the functions of the embodiments described above are realized by the processing.

Moreover, when the present invention is applied to the recording medium described above, the recording medium is to store program codes corresponding to the flow charts described earlier.

### Other Embodiments

The configurations described in the first to fourth embodiments may be used in combination with each other. Therefore, appropriately combining the various techniques presented in the respective embodiments described above to construct new systems is a concept easily devisable by a person skilled in the art. Accordingly, systems created by such various combinations also fall within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283718, filed on Dec. 26, 2011, which is hereby incorporated by reference herein in its entirety.

### REFERENCE SIGNS

101 imaging device
102 image data generating apparatus
103 display device
301 captured image data obtaining unit
305 display data generating unit
306 display data output unit
307 position data obtaining unit

1. An image data generating apparatus which uses data of a captured image to generate data of a display image to be displayed on a display device, the image data generating apparatus comprising:
a captured image data obtaining unit configured to obtain data of captured image;
a position data obtaining unit configured to obtain position data of a region of interest in the captured image instructed by a user; and
a display data generating unit configured to generate data of the display image based on the data of the captured image and the position data, wherein
the position data obtaining unit is configured to obtain and associate the position data of and display magnification factors for a plurality of the regions of interest,
the display data generating unit is further configured to generate first data for displaying the plurality of pieces of position data of and display magnification factors for the plurality of the regions of interest on the display device and second data for displaying a plurality of enlarged images simultaneously on the display device, each enlarged image being an enlargement of a part of the captured image,
plural pieces of position data associated with display magnification factors in a specified range can be collectively selected, the specified range being specified by the user from among the display magnification factors displayed on the display device, and
the display data generating unit is further configured to generate the plurality of the enlarged images so that each of the enlarged images includes a region of interest corresponding to one piece of collectively selected position data and is displayed at the display magnification factor associated with the piece of position data.

2-11. (canceled)

12. An image data display system comprising:
a captured image output device;
a display device; and
the image data generating apparatus according to claim 1,
wherein the image data generating apparatus uses data of a captured image outputted from the captured image output device to generate data of the display image to be displayed on the display device.

13. An image data generating method of using data of a captured image to generate data of a display image to be displayed on a display device, the image data generating method causing a computer to execute:
a captured image data obtaining step of obtaining data of the captured image;
a position data obtaining step of obtaining position data of a region of interest in the captured image instructed by a user; and
a display data generating step of generating data of the display image based on the data of the captured image and the position data, wherein
in the position data obtaining step, position data of and display magnification factors for a plurality of the regions of interest can be obtained and associated, and
in the display data generating step, first data for displaying the plurality of pieces of position data of and display magnification factors for the plurality of the regions of interest on the display device is generated, and second data for displaying a plurality of enlarged images simultaneously on the display device is generated, each enlarged image being an enlargement of a part of the captured image,
plural pieces of position data associated with display magnification factors in a specified range can be collectively selected, the specified range being specified by the user from among the display magnification factors displayed on the display device, and
the plurality of the enlarged images are generated so that each of the enlarged images includes a region of interest corresponding to one piece of collectively selected position data and is displayed at the display magnification factor associated with the piece of position data.

14. A non-transitory computer-readable medium storing a program causing a computer to execute the respective steps of the image data generating method according to claim 13.

15. The image data generating apparatus according to claim 1, wherein the display data generating unit is further configured to generate the first data and/or the second data so that the information of positions and/or the enlarged images is displayed in display modes according to display magnification factors.

16. The image data generating apparatus according to claim 1, wherein the display data generating unit is further configured to determine a display position of each enlarged image on the display device based on selection order of the position data corresponding to the enlarged image.

17. The image data generating apparatus according to claim 1, wherein the display data generating unit is further configured to determine display regions of the enlarged images on the display device based on the number of the selected pieces of position data.

18. The image data generating apparatus according to claim 1, wherein the display data generating unit is further configured to generate the first data so that selected pieces of position data are displayed in a display mode different from a display mode for unselected pieces of position data.

19. The image data generating apparatus according to claim 1, wherein
the display data generating unit is further configured to generate data for displaying a second enlarged image, the second enlarged image being an enlargement of a part of the captured image, wherein the part of the captured image is enlarged based on a position and a magnification factor specified by the user,
the position data obtaining unit is further configured to allow the user to select the region of interest on the second enlarged image displayed on the display device and to specify the display magnification factor at the time when the user selects the region of interest.

20. The image data generating apparatus according to claim 1, further comprising:
a storage unit configured to store a list which associates the plurality of pieces of position data and display magnification factors in association with the data of a captured image, and
a list matching unit configured to determine whether data of a captured image data associated with a list obtained from the storage unit is consistent with data of a captured image obtained by the captured image data obtaining unit.

21. An image data generating apparatus which uses data of a captured image to generate data of a display image to be displayed on a display device, the image data generating apparatus comprising:
a captured image data obtaining unit configured to obtain data of captured image;
a position data obtaining unit configured to obtain position data of a region of interest on the captured image instructed by a user; and
a display data generating unit configured to generate data of the display image based on the data of the captured image and the position data, wherein
the position data obtaining unit is capable of obtaining and associating the position data and display magnification factors for a plurality of the regions of interest,
the display data generating unit is further configured to generates first data for displaying the plurality of pieces of position data and display magnification factors for the plurality of the regions of interest on the display device and second data for displaying a plurality of enlarged images simultaneously on the display device, each enlarged image being an enlargement of a part of the captured image,
plural pieces of position data in a specified positional range can be collectively selected, the specified positional range being specified by the user, from among the plurality of pieces of position data displayed on the display device, and
the display data generation unit is further configured to generate the plurality of the enlarged images so that each of the enlarged images include a region of interest corresponding to one piece of collectively selected position data and is displayed at the display magnification factor associated with the piece of position data.

22. An image data generating apparatus which uses data of a captured image to generate data of a display image to be displayed on a display device, the image data generating apparatus comprising:
a captured image data obtaining unit configured to obtain data of captured image;
a position data obtaining unit configured to obtain position data of a region of interest on the captured image instructed by a user; and
a display data generating unit configured to generate data of the display image based on the data of the captured image and the position data, wherein
the position data obtaining unit is configured to obtain and associate the position data and display magnification factors for a plurality of the regions of interest,
the display data generating unit is further configured to generate first data for displaying the plurality of pieces of position data and display magnification factors for the plurality of the regions of interest on the display device in association with identifying marks, second data for displaying a plurality of enlarged images simultaneously on the display device, each enlarged image being an enlargement of a part of the captured image, and third data for displaying an entire image of the captured image, and
the display data generating unit is further configured to generate the plurality of the enlarged images so that each of the enlarged images includes a region of interest corresponding to position data selected by the user from among the plurality of pieces of position data displayed on the display device and to generate the entire image so that the identifying mark is displayed on the entire image at a position corresponding to the selected position data.

23. The image data generating apparatus according to claim 22, wherein the identifying mark is a serial number representing selection order of an associated region of interest.

24. An image data generating method of using data of a captured image to generate data of a display image to be displayed on a display device, the image data generating method causing a computer to execute:
a captured image data obtaining step of obtaining data of the captured image;
a position data obtaining step of obtaining position data of a region of interest on the captured image instructed by a user; and
a display data generating step of generating data of the display image based on the data of the captured image and the position data, wherein
in the position data obtaining step, position data and display magnification factor for a plurality of the regions of interest can be obtained and associated, and
in the display data generating step, first data for displaying to the plurality of pieces of position data and display magnification factors for the plurality of the regions of interest on the display device is generated, and second data for displaying a plurality of enlarged images simultaneously on the display device is generated, each enlarged image being an enlargement of a part of the captured image,
plural pieces of position data in a specified positional range specified by the user can be collectively selected from among the plurality of pieces of position data displayed on the display device, and
the plurality of the enlarged images are generated so that each of the enlarged images includes a region of interest corresponding to one piece of collectively selected position data and is displayed at a display magnification factor associated with the piece of position data.

25. An image data generating method of using data of a captured image to generate data of a display image to be displayed on a display device, the image data generating method causing a computer to execute:
a captured image data obtaining step of obtaining data of the captured image;
a position data obtaining step of obtaining position data of a region of interest on the captured image instructed by a user; and
a display data generating step of generating data of the display image based on the data of the captured image and the position data, wherein
in the position data obtaining step, position data and display magnification factor for a plurality of the regions of interest can be obtained and associated, and
in the display data generating step, first data for displaying the plurality of pieces of position data and display magnification factors for the plurality of the regions of interest on the display device is generated in association with identifying marks, second data for displaying a plurality of enlarged images simultaneously on the display device is generated, each enlarged image being an enlargement of a part of the captured image, and third data for displaying an entire image of the captured image is generated, and
the plurality of the enlarged images are generated so that each of the enlarged images includes a region of interest corresponding to position data selected by the user from among the plurality of pieces of position data displayed on the display device, and the entire image is generated so that the identifying mark is displayed on the entire image at a position corresponding to the selected position data.
